(19) United States
(12) Patent Application Publication
(10) Pub. No.: US 2023/0163429 A1
(43) Pub. Date: May 25, 2023

(54) SECONDARY BATTERY

(71) Applicant: MURATA MANUFACTURING CO., LTD., Koyoto (JP)

(72) Inventor: Daiki NISHIIE, Kyoto (JP)

(21) Appl. No.: 18/099,396

(22) Filed: Jan. 20, 2023

Related U.S. Application Data
(63) Continuation of application No. PCT/JP2021/024920, filed on Jul. 1, 2021.

(30) Foreign Application Priority Data
Jul. 22, 2020 (JP) 2020-124979

(51) Int. Cl. H01M 50/533; H01M 50/538

(52) U.S. Cl. CPC H01M 50/533; H01M 50/538

(57) ABSTRACT

Provided is a secondary battery including: a power storage element having an elongated cylindrical shape, a positive electrode having a positive electrode active material layer formed on a positive electrode current collector and a negative electrode having a negative electrode active material layer formed on a negative electrode current collector being wound around the power storage element; and an exterior body, in which at least two folding positions are provided on either the positive electrode or the negative electrode located at an innermost periphery of the power storage element, and when a distance between an end portion of the positive electrode active material layer on a winding start end portion side of the positive electrode and the folding position close to the end portion of the positive electrode active material layer is designated as a distance C1, a distance between an end portion of the positive electrode active material layer on a winding finish end portion side of the positive electrode and the folding position close to the end portion of the positive electrode active material layer is designated as a distance C2, and a length of the power storage element in a longitudinal direction is designated as W, the secondary battery satisfies relational expressions (1) and (2) below:

0.02≤C1/W≤0.12 Expression (1)

0.02≤C2/W≤0.12 Expression (2).

### CROSS REFERENCE TO RELATED APPLICATIONS

The present application is a continuation of PCT patent application no. PCT/JP2021/024920, filed on Jul. 1, 2021, which claims priority to Japanese patent application no. JP2020-124979, filed on Jul. 22, 2020, the entire contents of which are herein incorporated by reference.

### BACKGROUND

The present application relates to a secondary battery.

A secondary battery having a winding structure has been known in which a strip-shaped positive electrode and a strip-shaped negative electrode are wound with a strip-shaped separator interposed therebetween. A lithium ion battery is described as a secondary battery having such a winding structure. In the lithium ion battery described, an inner circumferential end portion of a positive electrode active material layer is formed in a region where the inner circumferential end portion does not overlap with a positive electrode tab in a short axis direction of the winding structure.

### SUMMARY

The present application relates to a secondary battery.

However, in the lithium ion battery described in the Background section, due to expansion and contraction of a power storage element accompanying a charge-discharge cycle, a stress is concentrated on a negative electrode current collector, and the negative electrode current collector is ruptured in some cases.

The present application relates to providing a secondary battery capable of suppressing rupture of a negative electrode current collector according to an embodiment.

In order to solve the above problems, the present application provides, in an embodiment, a secondary battery including:

a power storage element having an elongated cylindrical shape, a positive electrode having a positive electrode active material layer formed on a positive electrode current collector and a negative electrode having a negative electrode active material layer formed on a negative electrode current collector being wound around the power storage element; and

an exterior body, in which

at least two folding positions exist on either the positive electrode or the negative electrode located at an innermost periphery of the power storage element, and when a distance between an end portion of the positive

electrode active material layer on a winding start end portion side of the positive electrode and the folding position close to the end portion of the positive electrode active material layer is designated as a distance Cl, a distance between an end portion of the positive electrode active material layer on a winding finish end portion side of the positive electrode and the folding position close to the end portion of the positive electrode active material layer is designated as a distance C2, and a length of the power storage element in a longitudinal direction is designated as W, the secondary battery satisfies relational expressions (1) and (2) below:

0.02≤C1/W≤0.12 Expression (1)

0.02≤C2/W≤0.12 Expression (2).

According to the present application, rupture of a negative electrode current collector can be suppressed in an embodiment.

### BRIEF DESCRIPTION OF THE FIGURES

FIG. 1 is an exploded perspective view illustrating a configuration example of a non-aqueous electrolyte secondary battery according to an embodiment.

FIG. 2 is a sectional view taken along line II-II in FIG. 1.

FIG. 3 is a view for describing folding positions and the like according to an embodiment.

### DETAILED DESCRIPTION

Hereinafter, the present application will be described in further detail including with reference to the drawings according to an embodiment.

The present application will be described below including with reference to preferred specific examples according to an embodiment, and the contents of the present application are not limited thereto.

In a lithium ion battery having a winding structure, a portion where a positive electrode active material layer and a negative electrode active material layer face each other and a portion where the positive electrode active material layer and the negative electrode active material layer do not face each other may occur in a flat portion of the winding structure. During charging of the lithium ion battery, lithium is occluded in the negative electrode active material layer at the portion where the positive electrode active material layer and the negative electrode active material layer face each other, so that a negative electrode expands, but the negative electrode does not expand at the portion where the positive electrode active material layer and the negative electrode active material layer do not face each other. For this reason, distribution of stress accompanying expansion of the negative electrode becomes non-uniform during charging, and local stress concentration occurs. In particular, stress concentration occurs near a boundary between a flat portion and a curved portion in the winding structure. There is a problem in that a foil of a negative electrode current collector is ruptured due to concentration of stress. Hereinafter, an embodiment of the present application will be described in detail in view of the foregoing problems.

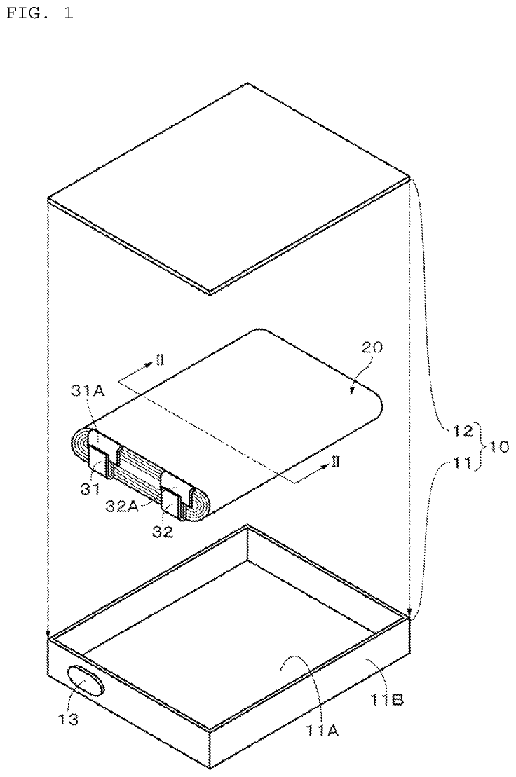

First, an example of a configuration of a non-aqueous electrolyte secondary battery (hereinafter, simply referred to as a “battery”) according to an embodiment will be described with reference to FIGS. 1 to 3. The battery has a flat shape as illustrated in FIG. 1. The battery includes a wound electrode body 20 to which a positive electrode tab (positive electrode lead) 31 and a negative electrode tab (negative electrode lead) 32 are attached and which has a flat shape, an electrolytic solution (not illustrated) as an electrolyte, and a case 10 which houses these electrode body 20 and electrolytic solution. When the battery is viewed in plan view from a direction perpendicular to a main surface of the battery, the battery has a rectangular shape.

The case 10, which is an example of an exterior body, is a thin battery can having a rectangular parallelepiped shape, and is formed using a metal. As the metal, for example, iron (Fe) plated with nickel (Ni) can be used. In the case of using a metal case, the case itself can also serve as a terminal of the battery by being connected to either the positive electrode or the negative electrode, and the battery is easily reduced in size. The case 10 includes a housing portion 11 and a lid portion 12. The housing portion 11 houses the electrode body 20. The housing portion 11 includes a main surface portion 11A and a wall portion 11B provided on a peripheral edge of the main surface portion 11A. The main surface portion 11A covers the main surface of the electrode body 20, and the wall portion 11B covers side surfaces and end surfaces of the electrode body 20. A positive electrode terminal 13 is provided in a portion of the wall portion 11B facing one end surface (an end surface on a side from which the positive electrode tab 31 and the negative electrode tab 32 are drawn) of the electrode body 20. The positive electrode tab 31 is connected to the positive electrode terminal 13. The negative electrode tab 32 is connected to the inside surface of the case 10. The lid portion 12 covers an opening of the housing portion 11. A top portion of the wall portion 11B of the housing portion 11 and a peripheral edge portion of the lid portion 12 are joined by welding, an adhesive, or the like. The case 10 may be a case having no rigidity such as a laminate film, but is preferably a metal case mainly formed using a metal. The metal case has constant rigidity and restrains the electrode body 20. Therefore, deformation of the battery due to expansion and contraction of the electrode body 20 can be suppressed, and the rupture of the negative electrode current collector can be suppressed.

The positive electrode tab 31 and the negative electrode tab 32 are led out from one end surface of the electrode body 20. Each of the positive electrode tab 31 and the negative electrode tab 32 is formed of, for example, a metal material such as Al, Cu, Ni, or stainless steel, and has a thin plate shape or the like.

Sealants (adhesive films) 31A and 32A for preventing intrusion of outside air are inserted between the case 10 and the positive electrode tab 31 and between the case 10 and the negative electrode tab 32, respectively. The sealants 31A and 32A is formed of a material having adhesion to the positive electrode tab 31 and the negative electrode tab 32, for example, a polyolefin resin such as polyethylene, polypropylene, modified polyethylene, or modified polypropylene.

The electrode body 20 is a power storage element having an elongated cylindrical shape, a positive electrode having a positive electrode active material layer formed on a positive electrode current collector and a negative electrode having a negative electrode active material layer formed on a negative electrode current collector being wound around the power storage element. The electrode body 20 will be described in detail.

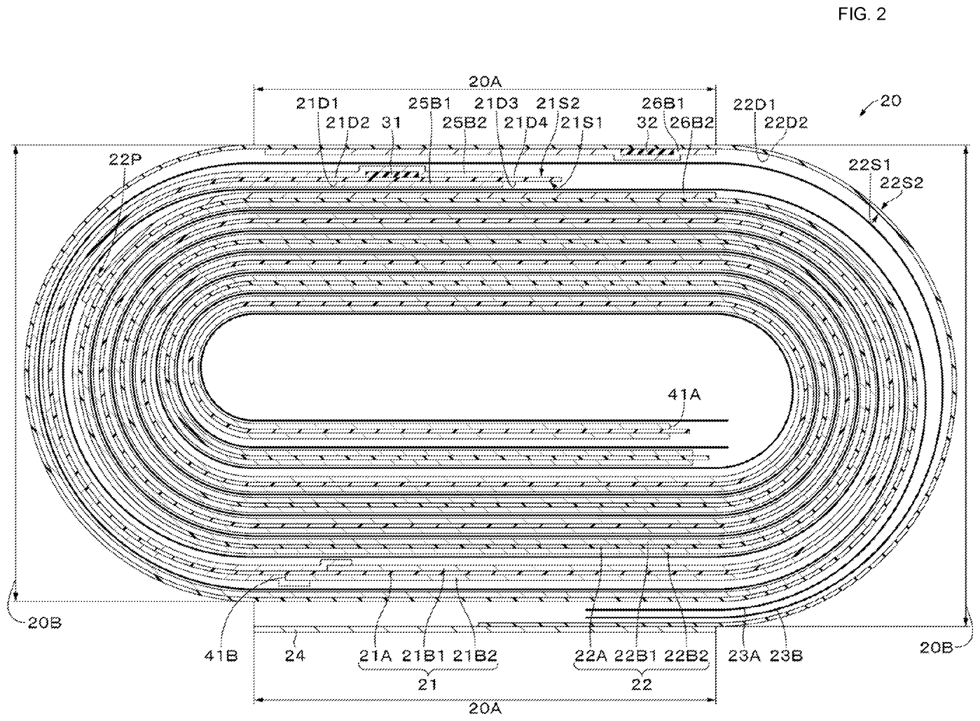

As illustrated in FIG. 2, the electrode body 20 has a pair of flat portions 20A facing each other and a pair of curved portions 20B provided between the pair of the flat portions 20A and facing each other. The electrode body 20 includes a positive electrode 21 having a strip shape, a negative electrode 22 having a strip shape, two separators 23A and 23B each having a strip shape, insulating members 25B1 and 25B2 provided on the positive electrode 21, and insulating members 26B1 and 26B2 provided on the negative electrode 22. The separators 23A and 23B are alternately provided between the positive electrode 21 and the negative electrode 22. The electrode body 20 has a configuration in which the positive electrode 21 and the negative electrode 22 are laminated with the separator 23A or the separator 23B interposed therebetween and are wound in a longitudinal direction so as to be flat and spiral. The electrode body 20 is wound such that the positive electrode 21 serves as an innermost peripheral electrode, whereas the negative electrode 22 serves as an outermost peripheral electrode. The negative electrode 22 as the outermost peripheral electrode is fixed with a winding termination tape 24. The positive electrode 21, the negative electrode 22, and the separators 23A and 23B are impregnated with an electrolytic solution.

The positive electrode 21 includes a positive electrode current collector 21A having an inside surface 21S1 and an outside surface 21S2, a positive electrode active material layer 21B1 provided on the inside surface 21S1 of the positive electrode current collector 21A, and a positive electrode active material layer 21B2 provided on the outside surface 21S2 of the positive electrode current collector 21A. In the present specification, the “inside surface” means a surface located on the winding center side, and the “outside surface” means a surface located on a side opposite to the winding center. The thickness of the positive electrode current collector 21A is, for example, 3 pm or more and 20 pm or less. The thickness of each of the positive electrode active material layers 21B1 and 21B2 is, for example, 30 pm or more and 100 pm or less.

The inside surface 21S1 of the end portion on the winding outer peripheral side (hereinafter, simply referred to as the “outer peripheral end portion”) of the positive electrode 21 is not provided with the positive electrode active material layer 21B1 but is provided with a positive electrode current collector exposed portion 21D1 at which the inside surface 21S1 of the positive electrode current collector 21A is exposed. The outside surface 21S2 of the outer peripheral end portion of the positive electrode 21 is not provided with the positive electrode active material layer 21B2 but is provided with a positive electrode current collector exposed portion 21D2 at which the outside surface 21S2 of the positive electrode current collector 21A is exposed. The positive electrode tab 31 is connected to a portion of the positive electrode current collector exposed portion 21D2 corresponding to the flat portion 20A. The length of the positive electrode current collector exposed portion 21D1 in a winding direction is, for example, substantially the same as the length of the positive electrode current collector exposed portion 21D2 in the winding direction.

The positive electrode current collector 21A is configured with, for example, a metal foil such as an aluminum foil, a nickel foil, or a stainless-steel foil. The positive electrode active material layers 21B1 and 21B2 contain a positive electrode active material capable of occluding and releasing lithium. The positive electrode active material layers 21B1 and 21B2 may further contain at least one of the binder and the conductive agent as necessary.

As the positive electrode active material, for example, a lithium-containing compound such as lithium oxide, lithium phosphorus oxide, lithium sulfide, or an intercalation compound containing lithium is suitable, and two or more kinds of these may be used in mixture. In order to increase the energy density, a lithium-containing compound which contains lithium, a transition metal element, and oxygen is preferable. Examples of such a lithium-containing compound include a lithium composite oxide having a layered rock-salt structure, and a lithium composite phosphate having an olivine structure. The lithium-containing compound more preferably contains, as a transition metal element, at least one selected from the group consisting of Co, Ni, Mn, and Fe. Examples of such a lithium-containing compound include LiNi_{0.50}Co_{0.20}Mn_{0.30}O₂, LiCoO₂, LiNiO₂, LiNiₐCo₁₋ₐ₂ (0<a<1), LiMn₂O₄, and LiFePO₄.

As the positive electrode active material capable of occluding and releasing lithium, inorganic compounds containing no lithium, such as MnO₂, V₂O₅, V₆O₁₃, NiS, and MoS, can also be used, in addition to these.

The positive electrode active material capable of occluding and releasing lithium may be other than those described above. Two or more kinds of the positive electrode active materials exemplified above may be mixed in any combination.

As the binder, for example, at least one selected from the group consisting of polyvinylidene difluoride, polytetrafluoroethylene, polyacrylonitrile, styrene butadiene rubber, carboxymethyl cellulose, copolymers containing one of these resin materials as a main component, and the like can be used.

As a conductive agent, for example, at least one carbon material selected from the group consisting of graphite, carbon fiber, carbon black, acetylene black, Ketjen black, carbon nanotube, graphene, and the like can be used. The conductive agent may be any material having conductivity, and is not limited to a carbon material. For example, a metal material, a conductive polymer material, or the like may be used as the conductive agent. Examples of the shape of the conductive agent include a granular shape, a scaly shape, a hollow shape, a needle shape, and a cylindrical shape, but are not particularly limited thereto.

The negative electrode 22 includes a negative electrode current collector 22A having an inside surface 22S1 and an outside surface 22S2, a negative electrode active material layer 22B1 provided on the inside surface 22S1 of the negative electrode current collector 22A, and a negative electrode active material layer 22B2 provided on the outside surface 22S2 of the negative electrode current collector 22A. The thickness of the negative electrode current collector 22A is, for example, 3 μm or more and 20 μm or less. The thickness of each of the negative electrode active material layers 22B1 and 22B2 is, for example, 30 μm or more and 100 μm or less.

The inside surface 22S1 of the outer peripheral end portion of the negative electrode 22 is not provided with the negative electrode active material layer 22B1 but is provided with a negative electrode current collector exposed portion 22D1 at which the inside surface 22S1 of the positive electrode current collector 21A is exposed. The outside surface 22S2 of the outer peripheral end portion of the negative electrode 22 is not provided with the negative electrode active material layer 22B2 but is provided with a negative electrode current collector exposed portion 22D2 at which the outside surface 22S2 of the negative electrode current collector 22A is exposed. The negative electrode tab 32 is connected to a portion of the negative electrode current collector exposed portion 22D1 corresponding to the flat portion 20A. The positive electrode tab 31 and the negative electrode tab 32 are provided on the same flat portion 20A side.

The length of the negative electrode current collector exposed portion 22D2 in the winding direction is longer than the length of the negative electrode current collector exposed portion 22D1 in the winding direction by about one periphery. That is, in the outer peripheral end portion of the negative electrode 22, a single-sided active material layer forming portion in which only the negative electrode active material layer 22B1 between the negative electrode active material layer 22B1 and the negative electrode active material layer 22B2 is formed on the negative electrode current collector 22A, is provided, for example, by about one periphery.

On the outermost periphery of the negative electrode 22, a portion at which both the inside surface 22S1 and the outside surface 22S2 of the negative electrode current collector 22A are exposed (that is, a portion in which the negative electrode current collector exposed portion 22D1 and the negative electrode current collector exposed portion 22D2 are provided on the both surfaces of the positive electrode 21) is provided, for example, by about one periphery. As a result, the negative electrode current collector exposed portion 22D2 and the inside surface of the case 10 are electrically brought into contact with each other. Therefore, the negative electrode 22 and the case 10 can be electrically connected to each other, and the resistance can be further reduced.

The negative electrode current collector 22A is configured with, for example, a metal foil such as a copper foil, a nickel foil, or a stainless-steel foil. In the present embodiment, a copper foil is used as the negative electrode current collector 22A. As the copper foil of the negative electrode current collector 22A, a copper foil, which contains impurities (for example, sulfur components) in the copper foil in an amount of 20 ppm (parts per million) or less and has an elongation rate after a heat treatment at 200° C. of 7% or more, is used. The elongation rate after the heat treatment at 200° C. means an elongation rate measured at normal temperature after heating at 200° C. for 3 hours. For example, a copper foil having an elongation rate of 7% or more is used, the elongation rate obtained as a result of performing a test using Autograph AG-IS manufactured by SHIMADZU CORPORATION, setting a measurement sample size to ASTM-D638-V (size of a maximum width value of 9.53 mm, a minimum width value of 3.15 mm, and a length orthogonal to the width of 63.50 mm) and a test speed to 1 mm/min, and then performing measurement at normal temperature after heating at 200° C. for 3 hours.

The negative electrode active material layers 22B1 and 22B2 contain a negative electrode active material capable of occluding and releasing lithium. The negative electrode active material layers 22B1 and 22B2 may further contain at least one of the binder and the conductive agent as necessary.

Examples of the negative electrode active material include carbon materials such as non-graphitizable carbon, graphitizable carbon, graphite, pyrolytic carbons, cokes, glassy carbons, organic polymer compound fired bodies, carbon fibers, and activated carbon. Of these, examples of the cokes include pitch coke, needle coke, and petroleum coke. The organic polymer compound fired body refers to a carbonized product obtained by firing a polymer material such as phenol resin or furan resin at an appropriate temperature, and some organic polymer compound fired bodies are classified as non-graphitizable carbon or graphitizable carbon. These carbon materials are preferred since the variation in the crystal structure occurred during charging and discharging is very small, and a high charge and discharge capacity as well as good cycle characteristics can be obtained. In particular, graphite is preferred since it has a large electrochemical equivalent and can obtain high energy density. Non-graphitizable carbon is preferable since excellent cycle characteristics can be attained. Those having a low charge and discharge potential, specifically those having a charge and discharge potential close to that of lithium metal are preferable since it is possible to easily realize a high energy density of the battery.

As the binder, the same material as those of the positive electrode active material layers 21B1 and 21B2 can be used.

As the conductive agent, the same material as those of the positive electrode active material layers 21B1 and 21B2 can be used.

The separators 23A and 23B separate the positive electrode 21 and the negative electrode 22 from each other, prevents short circuit of current due to the contact between both electrodes, and allows lithium ions to pass through. The separators 23A and 23B are configured with, for example, a porous film containing: polytetrafluoroethylene; a polyolefin resin (polypropylene (PP), polyethylene (PE), or the like); an acrylic resin; a styrene resin; a polyester resin; a nylon resin; or a resin obtained by blending these resins, and may have a structure in which two or more kinds of these porous films are laminated.

Of these, a porous membrane consisting of polyolefin is preferable because of having an excellent short-circuit preventing effect and allowing improvement in the safety of the battery by a shutdown effect. In particular, polyethylene enables to obtain a shutdown effect within a range of 100° C. or higher and 160° C. or lower and is also excellent in electrochemical stability, and hence is preferable as a material constituting the separators 23A and 23B. Among them, low-density polyethylene, high-density polyethylene, or linear polyethylene is suitably used because they have an appropriate fusing temperature and are easily available. In addition, a material obtained by copolymerizing or blending a resin having chemical stability with polyethylene or polypropylene can be used. Alternatively, the porous membrane may have a structure of three or more layers in which a polypropylene layer, a polyethylene layer, and a polypropylene layer are sequentially laminated. For example, it is desirable to have a three-layer structure of PP/PE/PP, and the mass ratio [wt %] of PP and PE is PP:PE=60:40 to 75:25. Alternatively, from the viewpoint of cost, the single layer substrate having 100 wt % of PP or 100 wt % of PE can also be used. The method for producing the separators 23A and 23B may be wet or dry.

As the separators 23A and 23B, nonwoven fabric may be used. As the fibers constituting the nonwoven fabric, aramid fibers, glass fibers, polyolefin fibers, polyethylene terephthalate (PET) fibers, nylon fibers, or the like can be used. These two or more kinds of fibers may be mixed to form a nonwoven fabric.

The electrolytic solution is a so-called non-aqueous electrolytic solution, and contains an organic solvent (non-aqueous solvent) and an electrolyte salt dissolved in the organic solvent. The electrolytic solution may contain a publicly known additive to improve battery characteristics. Instead of the electrolytic solution, an electrolyte layer containing an electrolytic solution and a polymer compound serving as a holding material for holding the electrolytic solution therein may be used. In this case, the electrolyte layer may be in a gel state.

As the organic solvent, cyclic carbonic acid esters such as ethylene carbonate and propylene carbonate can be used, and it is preferred to use one of ethylene carbonate and propylene carbonate, and particularly preferred to use both in mixture. This is because cycle characteristics can be further improved.

As the organic solvent, it is preferred to mix a chain carbonic acid ester such as diethyl carbonate, dimethyl carbonate, ethyl methyl carbonate, or methyl propyl carbonate, to these cyclic carbonic acid esters and use such mixture. This is because high ion conductivity can be obtained.

The organic solvent preferably further contains 2,4-difluoroanisole or vinylene carbonate. This is because 2,4-difluoroanisole can further improve discharge capacity, and vinylene carbonate can further improve cycle characteristics. Therefore, use of a mixture of these materials is preferable because the discharge capacity and the cycle characteristics can be further improved.

In addition to these, examples of the organic solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropionitrile, N,N-dimethylformamide, N-methylpyrrolidinone, N-methyloxazolidinone, N,N-dimethylimidazolidinone, nitromethane, nitroethane, sulfolane, dimethyl sulfoxide, and trimethyl phosphate.

A compound obtained by substituting at least a part of hydrogen in these organic solvents with fluorine may be preferable because the reversibility of the electrode reaction may be improved depending on the type of the electrode to be combined.

Examples of the electrolyte salt include lithium salts, and the lithium salts may be used singly or in mixture of two or more kinds thereof. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC (SO₂CF₃)₃, LiAlCl₄, LiSiF₆, LiCl, lithium difluoro[oxolato-O,O']borate, lithium bisoxalate borate, and LiBr. Of these, LiPF₆ is preferable because high ion conductivity can be obtained and cycle characteristics can be further improved.

The insulating members 25B1, 25B2, 26B1, and 26B2 each have, for example, a rectangular film shape, and each have an adhesive surface on one surface. More specifically, the insulating members 25B1, 25B2, 26B1, and 26B2 each include a substrate and an adhesive layer provided on the substrate. In the present specification, pressure sensitive adhesion is defined as a type of adhesion. In accordance with this definition, a pressure-sensitive layer is regarded as a type of adhesive layer. A film is also defined to include a sheet. As the insulating members 25B1, 25B2, 26B1, and 26B2, for example, an insulating tape is used. Examples of the material for the insulating members 25B1, 25B2, 26B1, and 26B2 include polyethylene terephthalate (PET), polyimide (PI), polyethylene (PE), and polypropylene (PP).

The insulating member 25B1 covers a step portion at a boundary between the positive electrode current collector exposed portion 21D1 and the positive electrode active material layer 21B1 and the positive electrode current collector exposed portion 21D1. The insulating member 25B2 covers a step portion at a boundary between the positive electrode current collector exposed portion 21D2 and the positive electrode active material layer 21B2 and the positive electrode current collector exposed portion 21D2. The insulating member 25B2 covers the positive electrode tab 31 together with the positive electrode current collector exposed portion 21D2. The boundary between the positive electrode current collector exposed portion 21D1 and the positive electrode active material layer 21B1 and the boundary between the positive electrode current collector exposed portion 21D2 and the positive electrode active material layer 21B2 are formed in parallel to a winding axis direction of the electrode body 20.

The insulating member 25B1 is provided in a region where the positive electrode current collector exposed portion 21D1 and the negative electrode active material layer 22B2 face each other and a region where the positive electrode current collector exposed portion 21D1 and the negative electrode current collector exposed portion 22D2 face each other. The insulating member 25B2 is provided in a region where the positive electrode current collector exposed portion 21D2 and the negative electrode active material layer 22B1 face each other and a region where the positive electrode current collector exposed portion 21D2 and the negative electrode current collector exposed portion 22D1 face each other.

The positive electrode 21 has a positive electrode current collector exposed portion 21D3 at which the outer peripheral end portion of the positive electrode current collector exposed portion 21D1 is exposed without being covered with the insulating member 25B1, and a positive electrode current collector exposed portion 21D4 at which the outer peripheral end portion of the positive electrode current collector exposed portion 21D2 is exposed without being covered with the insulating member 25B2.

The insulating member 26B1 covers a portion where the negative electrode tab 32 is provided and a portion facing the positive electrode current collector exposed portion 21D4, of the negative electrode current collector exposed portion 22D1. The insulating member 26B1 may cover almost the whole portion of the negative electrode current collector exposed portion 22D1 corresponding to one flat portion 20A.

The insulating member 26B2 covers a step portion at a boundary 22P between the negative electrode current collector exposed portion 22D2 and the negative electrode active material layer 22B2 (that is, the boundary 22P between the single-sided active material layer forming portion and the negative electrode active material layer 22B2) and the negative electrode current collector exposed portion 22D2. The boundary 22P between the negative electrode current collector exposed portion 22D2 and the negative electrode active material layer 22B2 is formed in parallel to the winding axis direction of the electrode body 20. The insulating member 26B2 also preferably covers a portion of the negative electrode current collector exposed portion 22D2 facing the positive electrode current collector exposed portion 21D3. The positive electrode current collector exposed portion 21D3 is located on the winding outer peripheral side of the electrode body 20 in relation to the boundary 22P, and the negative electrode tab 32 is located on the winding outer peripheral side of the electrode body 20 in relation to the positive electrode current collector exposed portion 21D3. The positive electrode current collector exposed portion 21D3 is located, for example, at the flat portion 20A on a side opposite to the flat portion 20A where the boundary 22P is provided.

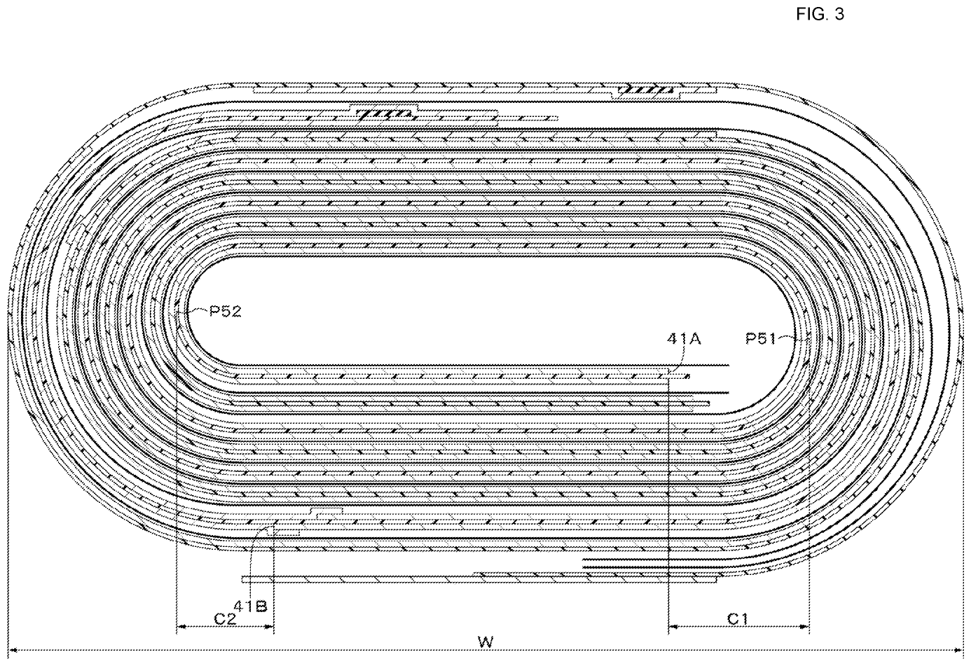

At least two folding positions exist on either the positive electrode or the negative electrode located at the innermost periphery of the power storage element. For example, as illustrated in FIG. 3, two folding positions P51 and P52 exist on the positive electrode 21 located at the innermost periphery of the electrode body 20 according to the present embodiment. Depending on the winding structure of the electrode body 20, the negative electrode 22 may exist on the innermost periphery, and a folding position of the negative electrode 22 may exist.

The positive electrode 21 constituting the electrode body 20 has a winding start end portion which is a start point of the winding structure and a winding finish end portion which is an end point of the winding structure. An end portion 41A of the positive electrode active material layer 21B1 exists on the winding start end portion side of the positive electrode 21. An end portion 41B of the positive electrode active material layer 21B1 exists on the winding finish end portion side of the positive electrode 21. A distance between the end portion 41A of the positive electrode active material layer 21B1 and the folding position P51 close to the end portion 41A of the positive electrode active material layer 21B1 (a distance of the electrode body 20 in the long axis direction) is designated as C1 (mm). A distance between the end portion 41B of the positive electrode active material layer 21B2 on the winding finish end portion side of the positive electrode 21 and the folding position P52 close to the end portion 41B of the positive electrode active material layer (a distance of the electrode body 20 in the long axis direction) is designated as a distance C2 (mm). When the positive electrode active material layers are formed on both surfaces of the positive electrode current collector 21A as in the present embodiment, the distance C1 or the distance C2 is defined by the end portion of the positive electrode active material layer closer to the folding position.

The length of the electrode body 20 in the longitudinal direction (long axis direction) is designated as W (mm). In this case, the battery satisfies relational expressions (1) and (2) below.

0.02≤C1/W≤0.12 Expression (1)

0.02≤C2/W<0.12 Expression (2)

The distances C1 and C2 may be equal (C1=C2) lengths.

As illustrated in FIG. 2, in the electrode body 20 according to the present embodiment, the positive electrode tab 31 and the negative electrode tab 32 are connected to the outermost periphery of the electrode body 20. Specifically, the positive electrode tab 31 is connected to the positive electrode current collector 21A located at the outermost periphery, and the negative electrode tab 32 is connected to the negative electrode current collector 22A located at the outermost periphery.

More specifically, the positive electrode tab 31 and the negative electrode tab 32 are located at the flat portion of the outermost periphery (the upper flat portion 20A in FIG. 2). The end portion 41A of the positive electrode active material layer 21B1 and the end portion 41B of the positive electrode active material layer 21B2 described above are located at the flat portion (the lower flat portion 20A in FIG. 2) on a side opposite to the flat portion on the side where the positive electrode tab 31 and the negative electrode tab 32 are located.

Next, an example of a method for manufacturing the battery according to an embodiment will be described.

The positive electrode 21 is produced as follows. First, for example, a positive electrode active material, a binder, and a conductive agent are mixed together to prepare a positive electrode mixture, and this positive electrode mixture is dispersed in a solvent such as N-methyl-2-pyrrolidone (NMP) to prepare a paste-like positive electrode mixture slurry. Next, this positive electrode mixture slurry is applied to both surfaces of the positive electrode current collector 21A, the solvent is dried, and compression molding is performed by, for example, a roll pressing machine to form the positive electrode active material layers 21B1 and 21B2, thereby obtaining the positive electrode 21. At this time, the coating position of the positive electrode mixture slurry is adjusted so that the positive electrode current collector exposed portions 21D1 and 21D2 are formed on one end of the positive electrode 21.

Next, the positive electrode tab 31 is attached to the positive electrode current collector exposed portion 21D2 provided on one end of the positive electrode 21 by welding. Next, the insulating members 25B1 and 25B2 are respectively bonded to the positive electrode current collector exposed portions 21D1 and 21D2 provided on one end of the positive electrode 21.

The negative electrode 22 is produced as follows. First, for example, a negative electrode active material and a binder are mixed together to prepare a negative electrode mixture, and this negative electrode mixture is dispersed in a solvent such as N-methyl-2-pyrrolidone to prepare a paste-like negative electrode mixture slurry. Next, this negative electrode mixture slurry is applied to both surfaces of the negative electrode current collector 22A, the solvent is dried, and compression molding is performed by, for example, a roll pressing machine to form the negative electrode active material layers 22B1 and 22B2, thereby obtaining the negative electrode 22. At this time, the coating position of the negative electrode mixture slurry is adjusted so that the negative electrode current collector exposed portions 22D1 and 22D2 are formed on one end of the negative electrode 22.

Next, the negative electrode tab 32 is attached to the negative electrode current collector exposed portion 22D1 provided on one end of the negative electrode 22 by welding. Next, the insulating members 26B1 and 26B2 are respectively bonded to the positive electrode current collector exposed portions 21D1 and 21D2 provided on one end of the negative electrode 22.

The positive electrode 21, the negative electrode 22, and the separators 23A and 23B are wound around a winding core at a prescribed length to produce the electrode body 20. The positive electrode 21 and the negative electrode 22 are cut in advance to a prescribed length.

The outer peripheral end portion of the negative electrode 22 is tilted in a predetermined direction (for example, downward) by a jig (not illustrated). The outer peripheral end portion of the negative electrode 22 tilted in this manner includes the boundary 22P between the negative electrode current collector exposed portion 22D2 and the negative electrode active material layer 22B2. Since the insulating member 26B2 covers the boundary 22P, rigidity of the negative electrode 22 at the boundary 22P can be increased, and bending of the outer peripheral end portion of the negative electrode 22 with the boundary 22P as a starting point can be suppressed. Therefore, it is possible to suppress the negative electrode active material from falling off from a portion of the negative electrode active material layer 22B1 located on the back surface side of the boundary 22P. Thus, it is possible to suppress occurrence of a minute short circuit due to falling off of the negative electrode active material. The outer peripheral end portion of the negative electrode 22 may be tilted by means other than a jig.

By attaching the negative electrode tab 32 in advance to the outer peripheral end portion of the negative electrode 22, the negative electrode tab 32 can function as a weight when the outer peripheral end portion of the negative electrode 22 is tilted. Therefore, the outer peripheral end portion of the negative electrode 22 can be easily tilted. Thus, in the “separator cutting step” which is a subsequent step of the bending step of the negative electrode end portion”, it is possible to suppress cutting of the negative electrode 22 together with the separators 23A and 23B.

The separators 23A and 23B are supported above the electrode body 20 by a support member (not illustrated), and then the separators 23A and 23B are cut by a cutter. After cutting, the outer peripheral end portion of the negative electrode 22 as the outermost peripheral electrode is fixed with the winding termination tape 24. As a result, the electrode body 20 is obtained.

In the state after winding, the negative electrode 22 is attracted to the separator 23A by static electricity. When the separators 23A and 23B are cut in this state, the negative electrode 22 is also cut together with the separators 23A and 23B, and there is a concern that the negative electrode 22 becomes shorter than a prescribed length. By cutting the separators 23A and 23B after the outer peripheral end portion of the negative electrode 22 is tilted as described above, it is possible to suppress cutting of the negative electrode 22 together with the separators 23A and 23B.

The electrode body 20 is sealed by the case 10 as follows. First, the electrode body 20 and an electrolytic solution are housed in the housing portion 11. Subsequently, the positive electrode tab 31 is connected to the positive electrode terminal 13 installed in the case 10, and the negative electrode tab 32 is connected to the inside surface of the case 10. Next, the opening of the housing portion 11 is covered with the lid portion 12, and the housing portion 11 and the peripheral edge portion of the lid portion 12 are joined by welding, an adhesive, or the like. Thereby, a battery is obtained.

In the present embodiment, the following effects can be obtained.

The ranges of the distances C1 and C2 are set to the ranges described in the embodiment, that is, the ranges satisfying both the relational expressions (1) and (2). As a result, it is possible to cause the positive electrode active material layer of the positive electrode and the positive electrode active material layer of the negative electrode to face each other in a wide range in each of the two flat portions. Therefore, expansion of the negative electrode during charging uniformly occurs in all directions, and it is possible to suppress local stress concentration in the electrode body. It is possible to suppress rupture of the negative electrode current collector due to local stress concentration.

Since the positive electrode tab and the negative electrode tab are provided on the outermost periphery, distortion of the positive electrode and the negative electrode becomes significant by the presence of the step difference of each lead, but the distance C1 and the distance C2 satisfy the relational expressions (1) and (2), respectively, so that rupture hardly occurs.

Two end portions of the positive electrode active material layer are located on the flat portion on a side opposite to the flat portion to which the positive electrode tab and the negative electrode tab are connected. Thereby, distortion portions of the positive electrode and the negative electrode caused by the step differences are symmetrical in plan view of the electrode. As a result, distortion can be dispersed and rupture can be further suppressed.

By setting the distance C1=C2, rupture of the negative electrode can be effectively suppressed.

By using, as a copper foil of the negative electrode current collector, a copper foil which contains impurities (for example, sulfur components) in the copper foil in an amount of 20 ppm or less and has an elongation rate after a heat treatment at 200° C. of 7% or more, it is possible to suppress rupture of the copper foil due to elongation of the copper foil during expansion.

### EXAMPLES

Hereinafter, the present application will be described with reference to Examples according to an embodiment; however, the present application is not limited only to these Examples.

### Examples 1 to 4

(Step of Producing Positive Electrode)

A positive electrode was produced as follows. First, a positive electrode mixture was prepared by mixing 91 parts by mass of lithium cobalt composite oxide (LiCoO₂) as a positive electrode active material, 6 parts by mass of graphite as a conductive agent, and 3 parts by mass of polyvinylidene fluoride as a binder, and then the positive electrode mixture was dispersed in N-methyl-2-pyrrolidone to prepare a paste-like positive electrode mixture slurry.

Next, a strip-shaped aluminum foil having a thickness of 19 pm was prepared as a positive electrode current collector, and the positive electrode mixture slurry was applied to both surfaces of this aluminum foil, dried, and then compression-molded using a roll pressing machine to form a positive electrode active material layer, thereby obtaining a positive electrode. At this time, the coating position of the positive electrode mixture slurry was adjusted so that a positive electrode current collector exposed portion was formed on each of both surfaces of one end portion of the positive electrode. Next, an aluminum positive electrode tab was welded and attached to the positive electrode current collector exposed portion to be the outside surface of the outer peripheral end portion after winding between the positive electrode current collector exposed portions formed on both surfaces of one end portion of the positive electrode. Next, an insulating tape was attached to each of the positive electrode current collector exposed portions formed on both surfaces of one end portion of the positive electrode (see FIG. 2).

(Step of Producing Negative Electrode)

A negative electrode was produced as follows. First, a negative electrode mixture was prepared by mixing 97 parts by mass of artificial graphite powder as a negative electrode active material and 3 parts by mass of polyvinylidene fluoride as a binder, and then the negative electrode mixture was dispersed in N-methyl-2-pyrrolidone to prepare a paste-like negative electrode mixture slurry.

Next, a strip-shaped copper foil having a thickness of 6 μm was prepared as a negative electrode current collector, and the negative electrode mixture slurry was applied to both surfaces of the copper foil, dried, and then compression-molded using a roll pressing machine to form a negative electrode active material layer, thereby obtaining a negative electrode. At this time, the coating position of the negative electrode mixture slurry was adjusted so that a negative electrode current collector exposed portion was formed on each of both surfaces of one end portion of the negative electrode. Next, a nickel negative electrode tab was welded and attached to the negative electrode current collector exposed portion to be the inside surface of the outer peripheral end portion after winding between the negative electrode current collector exposed portions formed on both surfaces of one end portion of the negative electrode. Next, an insulating tape was attached to each of the negative electrode current collector exposed portions formed on both surfaces of one end portion of the negative electrode (see FIG. 2).

(Step of Preparing Electrolytic Solution)

An electrolytic solution was prepared as follows. First, ethylene carbonate (EC) and propylene carbonate (PC) were mixed at a mass ratio of EC:PC=1:1 to prepare a mixed solvent. Next, lithium hexafluorophosphate (LiPF₆ as an electrolyte salt was dissolved in this mixed solvent so as to be 1.0 mol/kg, thereby preparing an electrolytic solution.

(Step of Producing Battery)

A battery was produced as follows. First, the positive electrode, and the negative electrode, and two separators were wound around a winding core to obtain a wound electrode body having a flat shape. As the separator, a microporous polyethylene film having a thickness of 25 μm was used. Subsequently, the outer peripheral end portion of the negative electrode was tilted with a jig. Next, the separator was supported above the electrode body by a support member, and then the separator was cut by a cutter. Thereafter, the outer peripheral end portion of the negative electrode as the outermost peripheral electrode was fixed with a winding termination tape. As a result, an electrode body was obtained. Next, the electrode body and the electrolytic solution were housed in a housing portion of a metal can, an opening of the housing portion was covered with a lid portion, and the housing portion and the peripheral edge portion of the lid portion were joined to seal the metal can. As a result, a target battery was obtained.

The length of the electrode body in the longitudinal direction was set to 25 mm. In the step of producing a positive electrode, the winding start position and the winding end position of the positive electrode current collector were appropriately adjusted. By adjusting the coating position of the positive electrode mixture slurry, the positions of the end portion of the positive electrode active material layer on the winding start end portion side of the positive electrode and the end portion of the positive electrode active material layer on the winding finish end portion side of the positive electrode were appropriately adjusted. The above adjustment was made so as to satisfy the relational expressions (1) and (2).

### Comparative Examples 1 to 4

Batteries were obtained in the same manner as in Example 1, except that the batteries were adjusted so as not to satisfy the relational expressions (1) and (2).

(Rupture Occurrence Rate)

The rupture occurrence rate was evaluated as follows. The battery was overcharged until the State of Charge (SOC) of the battery reached 150%, and the overcharged battery was disassembled. At this time, the rupture of the copper foil of the negative electrode current collector was visually checked, and the ratio of the total number of batteries in which rupture occurred to the number of batteries manufactured (evaluated number) was defined as a rupture occurrence rate. The number of batteries manufactured was set to 100.

(Rupture Occurrence Rate after Cycle Charging and Discharging)

The rupture occurrence rate after cycle charging and discharging was evaluated as follows. Under an environment of 40° C., charging and discharging of the battery at 1 C (Capacity)/1 C was regarded as 1 cycle, and charging and discharging was performed 10000 times of the number of cycles. The battery after cycle charging and discharging was disassembled. At this time, the rupture of the copper foil of the negative electrode current collector was visually checked, and the ratio of the total number of batteries in which rupture occurred to the number of batteries manufactured was defined as a rupture occurrence rate after cycle charging and discharging. The number of batteries manufactured was set to 100.

Table 1 shows the configurations of the batteries of Examples 1 to 4 and Comparative Examples 1 to 4, and evaluation results.

TABLE 1
W = 25 mm

| | | | | | | Rupture |
|---|---|---|---|---|---|---|
| | | | | | | occurrence rate |
| | | | | | Rupture | [%] after |
| | | | | | occurrence | 10000 cycles at |
| | C1 | C1/ | C2 | C2/ | rate | 40° C. and |
| | [mm] | W | [mm] | W | [%] | 1 C/1 C |
| Example 1 | 2.5 | 0.10 | 2.0 | 0.08 | 0 | 5 |
| Example 2 | 3.0 | 0.12 | 2.0 | 0.08 | 0 | 10 |
| Example 3 | 0.4 | 0.02 | 2.0 | 0.08 | 0 | 3 |
| Example 4 | 2.5 | 0.10 | 2.5 | 0.10 | 0 | 8 |
| Comparative | 3.2 | 0.13 | 2.0 | 0.08 | 21 | 69 |
| Example 1 | | | | | | |
| Comparative | 0.2 | 0.01 | 2.0 | 0.08 | 25 | 81 |
| Example 2 | | | | | | |
| Comparative | 2.0 | 0.08 | 0.2 | 0.01 | 32 | 90 |
| Example 3 | | | | | | |
| Comparative | 10.0 | 0.40 | 12.0 | 0.48 | 79 | 100 |
| Example 4 | | | | | | |

The following can be seen from Table 1.

In the batteries of Examples 1 to 4 in which C1/W and C2/W satisfied the relational expressions (1) and (2), the rupture occurrence rate could be set to 0%. On the other hand, in the batteries of Comparative Examples 1 to 4 in which C1/W and C2/W did not satisfy the relational expressions (1) and (2), the rupture occurrence rate was 20% or more.

In the batteries of Examples 1 to 4, the rupture occurrence rate after cycle charging and discharging could be set to 10% or less. On the other hand, in the batteries of Comparative Examples 1 to 4, the rupture occurrence rate after cycle charging and discharging was 60% or more.

As in Example 4, also in the case of C1=C2, the rupture occurrence rate was 0%, and the rupture occurrence rate after cycle charging and discharging was also as low as

As in Comparative Examples 1 to 3, also in the battery satisfying only one of the relational expressions (1) and (2), the rupture occurrence rate was as high as 21% to 32%, and the rupture occurrence rate after cycle charging and discharging was also as high as 69% to 90%.

### Examples 5 to 11

Next, batteries satisfying the relational expressions (1) and (2) were produced with C1/W=0.10 and C2/W=0.10. The method for producing a battery is the same as in Example 1. The same evaluation as in Example 1 and the like was performed while changing the sulfur content contained in the copper foil of the negative electrode current collector and the copper foil elongation rate.

Table 2 shows the configurations of the batteries of Examples 5 to 11, and evaluation results.

TABLE 2
(C1/W, C2/W = 0.10)

| | | | | Rupture |
|---|---|---|---|---|
| | | | | occurrence |
| | Copper foil | Copper foil | Rupture | rate [%] after |
| | sulfur | elongation | occurrence | 10000 cycles at |
| | content | rate | rate | 40° C. and |
| | [ppm] | [%] | [%] | 1 C./1 C. |
| Example 5 | 8.4 | 4.6 | 0 | 12 |
| Example 6 | 10.1 | 6.9 | 0 | 10 |
| Example 7 | 11.1 | 7 | 0 | 5 |
| Example 8 | 9.9 | 10.3 | 0 | 3 |
| Example 9 | 19.8 | 9.9 | 0 | 8 |
| Example 10 | 20 | 7.5 | 0 | 2 |
| Example 11 | 23 | 11 | 0 | 11 |

The following can be seen from Table 2.

In the batteries of Examples 5 to 11 in which C1/W and C2/W satisfied the relational expressions (1) and (2), the rupture occurrence rate could be set to 0%. The rupture occurrence rate after cycle charging and discharging could be set to 12% or less.

In Examples 7 to 10 in which the copper foil sulfur content contained in the copper foil of the negative electrode current collector was 20 ppm or less and the copper foil elongation rate was 7% or more, the rupture occurrence rate could be set to one digit (8% or less).

### Comparative Examples 5 to 11

Next, batteries not satisfying the relational expressions (1) and (2) were produced with C1/W=0.40 and C2/W=0.48. The method for producing a battery is the same as in Example 1. The same evaluation as in Example 1 and the like was performed while changing the sulfur content contained in the copper foil of the negative electrode current collector and the copper foil elongation rate.

Table 3 shows the configurations of the batteries of Comparative Examples 5 to 11, and evaluation results.

TABLE 3
(C1/W = 0.40, C2/W = 0.48)

| | | | | Rupture |
|---|---|---|---|---|
| | | | | occurrence |
| | Copper foil | Copper foil | Rupture | rate [%] after |
| | sulfur | elongation | occurrence | 10000 cycles at |
| | content | rate | rate | 40° C. and |
| | [ppm] | [%] | [%] | 1 C./1 C. |
| Comparative | 8.4 | 4.6 | 69 | 100 |
| Example 5 | | | | |
| Comparative | 10.1 | 6.9 | 72 | 100 |
| Example 6 | | | | |
| Comparative | 11.1 | 7 | 78 | 100 |
| Example 7 | | | | |
| Comparative | 9.9 | 10.3 | 79 | 100 |
| Example 8 | | | | |
| Comparative | 19.8 | 9.9 | 80 | 100 |
| Example 9 | | | | |
| Comparative | 20 | 7.5 | 78 | 100 |
| Example 10 | | | | |
| Comparative | 23 | 11 | 72 | 100 |
| Example 11 | | | | |

The following can be seen from Table 3.

In the batteries of Comparative Examples 5 to 11 in which C1/W and C2/W did not satisfy the relational expressions (1) and (2), the rupture occurrence rate was a high value that is 69% or more. All of the rupture occurrence rates after cycle charging and discharging were 100%. As described above, in the battery in which C1/W and C2/W did not satisfy the relational expressions (1) and (2), both the rupture occurrence rate and the rupture occurrence rate after cycle charging and discharging were high values when the copper foil sulfur content and the copper foil elongation rate were changed.

In the foregoing, the present application has been described according to an embodiment; however, the present application is not limited thereto including the Examples set forth herein, and various modifications may be made.

For example, the configurations, the methods, the steps, the shapes, the materials, the numerical values, and the like are merely examples, and configurations, methods, steps, shapes, materials, numerical values, and the like that are different from these examples, may be employed as necessary. The configurations, methods, steps, shapes, materials, numerical values and the like can be combined with each other.

The chemical formulas of compounds and the like are representative, and the valences and the like are not limited to those stated as long as the names are general names of the same compounds. In the numerical ranges listed in a stepwise manner, the upper limit value or the lower limit value of the numerical range in a certain stage may be replaced with the upper limit value or the lower limit value of the numerical range in another stage. The materials exemplified above embodiments can be used singly or in combination of two or more kinds, unless otherwise specified.

### DESCRIPTION OF REFERENCE SYMBOLS

10: Case

20: Electrode body

20A: Flat portion

21: Positive electrode

21A: Positive electrode current collector

21B1, 21B2: Positive electrode active material layer

22: Negative electrode

22A: Negative electrode current collector

22B1, 22B2: Negative electrode active material layer

23A, 23B: Separator

31: Positive electrode tab

32: Negative electrode tab

41A, 41B: End portion

P51, P52: Folding position

It should be understood that various changes and modifications to the presently preferred embodiment described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a power storage element having an elongated cylindrical shape, a positive electrode having a positive electrode active material layer formed on a positive electrode current collector and a negative electrode having a negative electrode active material layer formed on a negative electrode current collector being wound around the power storage element; and
an exterior body, wherein
at least two folding positions are provided on either the positive electrode or the negative electrode located at an innermost periphery of the power storage element, and
when a distance between an end portion of the positive electrode active material layer on a winding start end portion side of the positive electrode and the folding position close to the end portion of the positive electrode active material layer is designated as a distance C1, a distance between an end portion of the positive electrode active material layer on a winding finish end portion side of the positive electrode and the folding position close to the end portion of the positive electrode active material layer is designated as a distance C2, and a length of the power storage element in a longitudinal direction is designated as W, the secondary battery satisfies relational expressions (1) and (2) below:
0.02≤C1/W<0.12 Expression (1)
0.02≤C2/W<0.12 Expression (2).

2. The secondary battery according to claim 1, wherein a positive electrode tab and a negative electrode tab are connected to an outermost periphery of the power storage element.

3. The secondary battery according to claim 2, wherein the positive electrode tab and the negative electrode tab are located at a flat portion of the outermost periphery, and
the end portion of the positive electrode active material layer on the winding start end portion side of the positive electrode and the end portion of the positive electrode active material layer on the winding finish end portion side of the positive electrode are located at a flat portion on a side opposite to the flat portion on a side where the positive electrode tab and the negative electrode tab are located.

4. The secondary battery according to claim 1, wherein a sulfur content contained in the negative electrode current collector is 20 ppm or less, and an elongation rate of the negative electrode current collector is 7% or more.
